(19) United States
(12) Patent Application Publication
(10) Pub. No.: US 2023/0322189 A1
(43) Pub. Date: Oct. 12, 2023

(54) AUTOMATIC CAR WASHING APPARATUS

(71) Applicant: Suk Won YANG, Seoul (KR)

(72) Inventor: Suk Won YANG, Seoul (KR)

(21) Appl. No.: 18/022,674

(22) PCT Filed: Sep. 14, 2021
(86) PCT No.: PCT/KR2021/012508

§ 371 Date: Feb. 22, 2023

(30) Foreign Application Priority Data
Sep. 18, 2020 (KR) 10-2020-0120515

(51) Int. Cl. B60S 3/04; B08B 3/02; B08B 5/02

(52) U.S. Cl. CPC B60S 3/04; B08B 3/024; B08B 5/02

(57) ABSTRACT

An embodiment of the present invention provides an automatic car washing apparatus including: a frame module unit configured to provide a vehicle accommodation space, and provided with guide frames; a movable module unit configured to move along the guide frames, and provided with a blower unit that sprays air toward the vehicle accommodation space; and a car washing module unit coupled to a rotor unit that is provided in the movable module unit, and configured to perform a washing operation on a vehicle that has entered the vehicle accommodation space; wherein the car washing module unit is configured to rotate around the vertical axis of the rotor unit.

### TECHNICAL FIELD

The present invention relates to an automatic car washing apparatus, and more particularly, to an automatic car washing apparatus having a simple structure.

### BACKGROUND ART

In general, in automatic car washing apparatuses for automatically washing a vehicle, a rotating brush performs car washing while rotating along the surfaces of the body of a vehicle. These automatic car washing apparatuses are basically classified into a tunnel type and a movable type.

However, the tunnel- or movable-type automatic car washing apparatuses have a problem in that they occupy a large installation space. In addition, the tunnel- or movable-type automatic car washing apparatuses have a problem in that the initial installation costs are high due to the complicated configuration thereof. Furthermore, in the tunnel- or movable-type automatic car washing apparatuses, a car washing operation is performed in the state in which a rotating brush comes into direct contact with the surfaces of a vehicle, so that scratches may occur on the surface of the vehicle.

Due to this problem, a no-brush type automatic car washing apparatus that performs car washing by spraying high-pressure washing water and detergent water has been developed. However, the conventional no-brush type automatic car washing apparatus has a problem in that the installation costs are high due to the complicated structure thereof.

More specifically, the conventional no-brush type automatic car washing apparatus has a problem in that it has a complicated structure because it needs to be provided with two side surface washing units for washing both sides of a vehicle and an upper portion washing unit for washing the upper portion of the vehicle.

Therefore, various researches and developments have been conducted on no-brush type automatic car washing apparatuses having a simple structure.

Prior Art Document 1: Korean Patent Application Publication No. 2012-0046381 (published on May 10, 2012)

### DISCLOSURE

### Technical Problem

To solve the above problems, a technical problem of the present invention is to provide an automatic car washing apparatus having a simple structure.

### Technical Solution

In order to overcome the above technical problem, an embodiment of the present invention provides an automatic car washing apparatus including: a frame module unit configured to provide a vehicle accommodation space, and provided with guide frames; a movable module unit configured to move along the guide frames, and provided with a blower unit that sprays air toward the vehicle accommodation space; and a car washing module unit coupled to a rotor unit that is provided in the movable module unit, and configured to perform a washing operation on a vehicle that has entered the vehicle accommodation space; wherein the car washing module unit is configured to rotate around the vertical axis of the rotor unit.

In an embodiment of the present invention, the frame module unit may include: main frames having a front frame and a rear frame that are spaced apart from each other by a predetermined distance and form the vehicle accommodation space; support frames configured to connect the front frame and the rear frame; the guide frames configured to connect the front frame and the rear frame and to guide the movable module unit through the moving direction thereof; a front bracket protruding from the front frame toward the rear frame; a rear bracket protruding from the rear frame toward the front frame; a parking sensor unit installed on the front bracket, and configured to guide a vehicle, entering the vehicle accommodation space, to a parking location; a front sensor unit spaced apart from the parking sensor unit by a predetermined distance, and installed on the front bracket; and a rear sensor unit installed on the rear bracket.

In an embodiment of the present invention, the movable module unit may include: a casing having an installation space formed therein; the blower unit provided in the installation space; the rotor unit provided in the installation space, and configured to rotate the car washing module unit; roller parts provided on both sides of the casing, and configured to move along the longitudinal directions of the guide frames; an extension part extending rearward from the center of the casing; and a vehicle location sensor unit provided at an end of the extension part, and configured to detect the parking location of a vehicle entering the vehicle accommodation space.

In an embodiment of the present invention, the car washing module unit may include: a horizontal spray arm coupled to the rotor unit; a connection spray arm configured such that one end thereof is connected to an end of the horizontal spray arm at a predetermined angle; and a vertical spray arm connected to the other end of the connection spray arm; and a plurality of spray holes may be formed in each of the horizontal spray arm, the connection spray arm, and the vertical spray arm at predetermined intervals along a longitudinal direction thereof.

In an embodiment of the present invention, the automatic car washing apparatus may further include an entry guide unit configured to provide guidance to a parking location with respect to the widthwise direction of a vehicle entering the vehicle accommodation space, and a bottom washing spray unit may be provided on the bottom surface of the vehicle accommodation space.

### Advantageous Effects

The effects of the automatic car washing apparatus according to the present invention described above are described as follows:

According to the present invention, the car washing module unit is configured to be rotatable with respect to the rotor unit provided in the movable module unit. Accordingly, the automatic car washing apparatus may effectively wash the exterior of the vehicle while having a simple structure. In other words, the automatic car washing apparatus according to the present invention may effectively wash the overall exterior of a vehicle with only the single car washing module unit.

The effects of the present invention are not limited to the above-described effects, and it should be understood that there are included all effects that can be derived from the configuration of the invention described in the detailed description of the present invention or the claims.

### DESCRIPTION OF DRAWINGS

FIG. 1 is a perspective view of an automatic car washing apparatus according to an embodiment of the present invention;

FIG. 2 is an exemplary view schematically showing the operating states of the automatic car washing apparatus according to the embodiment of the present invention; and

FIG. 3 is an exemplary view showing a car washing module unit according to an embodiment of the present invention.

### BEST MODE

The present invention will be described below with reference to the accompanying drawings. However, the present invention may be implemented in various different forms and, accordingly, is not limited to the embodiments described herein. Furthermore, parts unrelated to the description are omitted in the drawings in order to clearly describe the present invention, and like reference numerals are assigned to like parts throughout the specification.

Throughout the specification, when a part is described as being “connected” to another part, this includes not only the case where they are “directly connected” to each other but also the case where they are “indirectly connected” with another member interposed therebetween. Furthermore, when a part is described as “including” a component, this means that the part may further include another component rather than excluding another component unless otherwise stated.

In the present invention, the upper and lower portions mean that they are located in the upper or lower portion of a target member, and do not necessarily mean that they are located in an upper or lower portion based on the direction of gravity.

Embodiments of the present invention will be described in detail below with reference to the accompanying drawings.

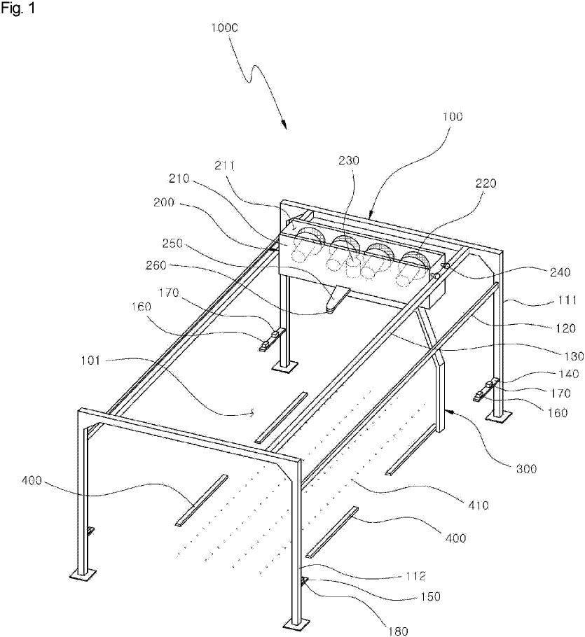

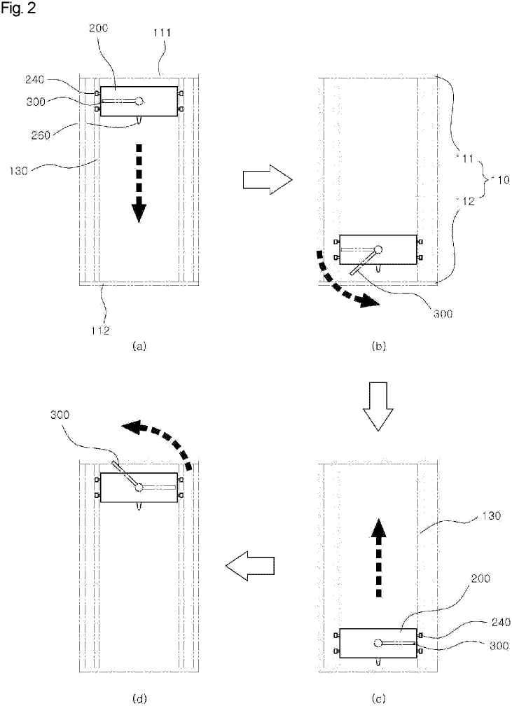

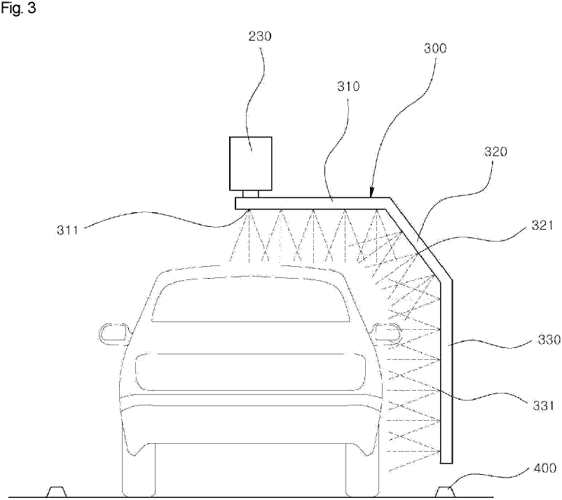

FIG. 1 is a perspective view of an automatic car washing apparatus according to an embodiment of the present invention, FIG. 2 is an exemplary view schematically showing the operating states of the automatic car washing apparatus according to the embodiment of the present invention, and FIG. 3 is an exemplary view showing a car washing module unit according to an embodiment of the present invention.

As shown in FIGS. 1 to 3, an automatic car washing apparatus 1000 may include a frame module unit 100, a movable module unit 200, and a car washing module unit 300.

In this case, the frame module unit 100 forms the skeleton of the automatic car washing apparatus 1000.

The frame module unit 100 may include main frames 110, support frames 120, guide frames 130, a front bracket 140, a rear bracket 150, a parking sensor unit 160, a front sensor unit 170, and a rear sensor unit 180.

In this case, the main frames 110 may have a front frame 111 and a rear frame 112. The front frame 111 and the rear frame 112 are spaced apart from each other by a predetermined distance, and provide a vehicle accommodation space 101.

In addition, the support frames 120 connect the front frame 111 and the rear frame 112, and form the skeleton of the frame module unit 100 together with the main frames 110. These support frames 120 are configured to support and fix the front frame 111 and the rear frame 112. In this case, although the number of support frames 120 is described as two by way of example in the present invention, the number of support frames 120 may be provided as various numbers.

In addition, the guide frames 130 connect the front frame 111 and the rear frame 112 like the support frames 120.

The guide frames 130 guide roller parts 240 provided in the movable module unit 200 through the moving direction thereof. In this case, a guide groove for the stable movement of the roller parts 240 may be further formed in each of the guide frames 130. The guide grooves may allow the roller parts 240 to stably move and also prevent the roller parts 240 from being separated.

In addition, the front bracket 140 protrudes from the front frame 111. The front bracket 140 protrudes toward the rear frame 112. The parking sensor unit 160 and the front sensor unit 170 may be installed on the front bracket 140.

In this case, the parking sensor unit 160 guides a vehicle, entering the vehicle accommodation space 101 for the purpose of car washing, toward a parking location. For example, the parking sensor unit 160 guides a vehicle, entering the vehicle accommodation space 101, toward a parking location in the state in which a light emission unit and a light reception unit form a pair. In other words, it is sufficient if a vehicle user parks the vehicle at a point detected by the parking sensor unit 160.

In this case, the state information detected by the parking sensor unit 160 may provide the location information of the corresponding vehicle to the vehicle user through, for example, a color indicator light. For example, when a vehicle is detected by the parking sensor unit 160, a green light may be turned on in the color indicator light.

In addition, the front sensor unit 170 is spaced apart from the parking sensor unit 160.

The front sensor unit 170 is disposed closer to the front frame 111 than the parking sensor unit 160. In this case, the front sensor unit 170 detects the location of a vehicle entering the vehicle accommodation space 101 in the state in which a light emission unit and a light reception unit form a pair, like the parking sensor unit 160.

The front sensor unit 170 detects a limit point that the front side of a vehicle entering the vehicle accommodation space 101 should not cross. In this case, when a vehicle moves forward and enters the vehicle accommodation space 101, the portion detected by the front sensor unit 170 may be the front bumper portion of the vehicle. When the vehicle is detected by the front sensor unit 170 as described above, a red light may be turned on in the color indicator light. Accordingly, the vehicle user may park the vehicle at an exact car wash location required for car washing while checking the color indicator light.

In addition, the rear sensor unit 180 is installed on the rear bracket 150 that protrudes from the rear frame 112. In this case, the rear bracket 150 protrudes toward the front frame 111.

The rear sensor unit 180 detects a limit point that the rear side of a vehicle entering the vehicle accommodation space 101 should not cross, like the front sensor unit 170. In this case, the rear side of the vehicle may be, for example, the rear bumper portion of the vehicle.

When a vehicle is detected by the rear sensor unit 180 as described above, a red light may be turned on in the color indicator light. In other words, the front sensor unit 170, the parking sensor unit 160, and the rear sensor unit 180 are configured to provide the accurate car wash location information of a vehicle for car washing to a vehicle user.

The front sensor unit 170, the parking sensor unit 160, and the rear sensor unit 180 provide guidance to a car wash location with respect to the longitudinal direction of the automatic car washing apparatus 1000.

In addition, the automatic car washing apparatus 1000 may further include an entry guide unit 400.

In this case, the entry guide unit 400 is configured to provide guidance to a parking location with respect to the widthwise direction of a vehicle entering the vehicle accommodation space 101.

As described above, a vehicle entering the vehicle accommodation space 101 may be parked at a car wash location required by the three sensor units and the entry guide unit 400 described above.

Meanwhile, a bottom washing spray unit 410 may be further provided on the floor of a place where the vehicle accommodation space 101 is located. The bottom washing spray unit 410 is fabricated in the form of holes, and is configured to spray washing water or cleaning liquid to the lower side and wheels of a vehicle. In other words, a vehicle entering the vehicle accommodation space 101 for the purpose of car washing may be automatically washed by the bottom washing spray unit 410 for the lower side and wheels of the vehicle.

Meanwhile, the movable module unit 200 is configured to be movable along the longitudinal direction of the frame module unit 100.

The movable module unit 200 may include a casing 210, a blower unit 220, a rotor unit 230, the roller parts 240, an extension part 250, and a vehicle location sensor unit 260.

In this case, the casing 210 forms the exterior of the movable module unit 200.

An installation space 211 may be formed inside the casing 210, and the blower unit 220 and the rotor unit 230 may be installed in the installation space 211.

In addition, the blower unit 220 is provided in the installation space 211. The blower unit 220 is configured to spray high-pressure air to, for example, the exterior of a vehicle that has been washed and cleaned. Accordingly, the water remaining on the exterior of a vehicle in the process of washing and cleaning the vehicle may be removed by the air blown from the blower unit 220.

In this case, when the blower unit 220 removes the water present on the exterior of a vehicle as a whole in the process in which the movable module unit 200 moves from the front side of the frame module unit 100 to the rear side thereof, it is preferable that air be blown in the state in which the discharge direction of the air blown from the blower unit 220 is not a vertical direction but a predetermined inclined direction. This is intended to more effectively remove water remaining on the vehicle.

In addition to drying the exterior of a vehicle, the blower unit 220 may selectively control the pressure of the sprayed washing water and cleaning liquid when the car washing module unit 300 sprays the washing water and the cleaning liquid.

In addition, the rotor unit 230 is provided in the installation space 211. The rotor unit 230 is configured to rotate the car washing module unit 300. Accordingly, the car washing module unit 300 may be selectively rotated by 360° based on the rotor unit 230. Therefore, the car washing module unit 300 may wash the overall exterior of a vehicle, such as both sides of the vehicle and the front and rear surfaces of the vehicle, through the rotation of the rotor unit 230.

As described above, the movable module unit 200 may selectively move along the longitudinal direction of the frame module unit 100, and the car washing module unit 300 may selectively rotate based on the movable module unit 200. Accordingly, the automatic car washing apparatus 1000 may wash the overall exterior of a vehicle located in the vehicle accommodation space 101.

In this case, the roller parts 240 are provided on both sides of the casing 210 so that the moving module unit 200 can be selectively moved along the longitudinal direction of the frame module unit 100.

In addition, the extension part 250 may extend from the rear of the casing 210 and be disposed at the center of the casing 210.

In addition, the vehicle location sensor unit 260 may be provided at an end of the extension part 250.

The vehicle location sensor unit 260 is configured to detect the location of the rear end portion of a vehicle entering the vehicle accommodation space 101. The vehicle location sensor unit 260 may be formed of, for example, a distance sensor. When a measured distance measured from the vehicle location sensor unit 260 is measured as a preset distance, for example, the distance from the floor to the vehicle location sensor unit in the state in which a vehicle is not present, the vehicle location sensor unit 260 may detect the location of a vehicle by detecting a corresponding point as the rear end portion of the vehicle.

As described above, the vehicle location sensor unit 260 is configured to accurately measure the location of the rear end portion of a vehicle so that a washing operation suitable for the corresponding vehicle can be effectively performed for various vehicles having various overall lengths.

Meanwhile, the car washing module unit 300 is configured to perform a washing operation on a vehicle that has entered the vehicle accommodation space 101.

The car washing module unit 300 may include a horizontal spray arm 310, a connection spray arm 320, and a vertical spray arm 330. The horizontal spray arm 310, the connection spray arm 320, and the vertical spray arm 330 may be connected to and integrated with each other.

In this case, one end of the horizontal spray arm 310 is coupled to the rotor unit 230. The rotor unit 230 is located at the center of the movable module unit 200 in the widthwise direction thereof.

In addition, the horizontal spray arm 310 coupled to the rotor unit 230 may be selectively rotated in a rotation range of 360° around the vertical axis of the rotor unit 230 by the rotation of the rotor unit 230.

A plurality of first spray holes 311 may be formed in the horizontal spray arm 310 at predetermined intervals along the longitudinal direction of the horizontal spray arm 310. The first spraying holes 311 are configured to spray washing water, cleaning liquid, and water-repellent coating liquid toward a vehicle. In this case, the first spray holes 311 are configured to perform a car washing operation on the upper portion of the exterior of a vehicle, i.e., the roof, bonnet, and trunk of the vehicle.

In addition, one end of the connection spray arm 320 is coupled to the other end of the horizontal spray arm 310.

The connection spray arm 320 is connected from the horizontal spray arm 310 at a predetermined angle. A plurality of second spray holes 321 may be formed in the connection spray arm 320 at predetermined intervals along the longitudinal direction of the connection spray arm 320.

The second spray holes 321 are configured to spray washing water, cleaning liquid, and water-repellent coating liquid toward a vehicle. In this case, the second spray holes 321 are configured to perform a car washing operation on connection portions between the upper and side portions of the exterior of a vehicle.

In addition, one end of the vertical spray arm 330 is coupled to the other end of the connection spray arm 320.

A plurality of third spray holes 331 may be formed in the vertical spray arm 330 at predetermined intervals along the longitudinal direction of the vertical spray arm 330. The third spray holes 331 are configured to perform a car washing operation on the side portions of the exterior of a vehicle, i.e., the doors of the vehicle.

The operation process of the automatic car washing apparatus 1000 described above will be described in brief. First, while a vehicle enters the vehicle accommodation space 101, the bottom washing spray unit 410 sprays washing water or cleaning liquid to the lower side and wheels of the vehicle and thus performs a car washing operation on the lower side of the vehicle.

Thereafter, the car washing module unit 300 performs a car washing operation on the exterior of the vehicle in a stepwise manner while moving along the longitudinal direction of the frame module unit 100 together with the movable module unit 200 and, simultaneously, rotating with respect to the movable module unit 200.

For example, a first-step car washing operation may be the step of spraying washing water to the overall exterior of the vehicle.

In addition, a second-step car washing operation may be the step of spraying washing liquid to the overall exterior of the vehicle. In other words, the second-step car washing operation may be the step of removing foreign substances and the like present on the exterior of the vehicle through a bubble pump wash operation.

In addition, a third-step car washing operation may be the step of spraying high-pressure washing water to the overall exterior of the vehicle. In this third-step car washing operation, foreign substances including washing liquid present on the exterior of the vehicle are removed.

In addition, a fourth-step car washing may be the step of spraying water-repellent coating liquid to the overall exterior of the vehicle.

As described above, the car washing module unit 300 performs a car washing operation while selectively spraying washing water, cleaning liquid, and water-repellent coating liquid at each stage. In this case, the stepwise car washing operation of the car washing module unit 300 does not necessarily have to be performed only in the above-mentioned steps, but it is obvious that the stepwise car washing operation may be composed of various steps.

Finally, the blower unit 220 removes water from the exterior of the vehicle by spraying high-pressure air to the exterior of the vehicle on which the washing and cleaning operation has been performed.

However, this is only a preferred embodiment of the present invention, and the scope of the present invention is not limited by the scope of the description of this embodiment.

The foregoing description of the present invention is intended for illustrative purposes, and those having ordinary skill in the art to which the present invention pertains can understand that modification into other specific forms may be easily made without changing the technical spirit or essential features of the present invention. Accordingly, the embodiments described above should be understood in all respects as illustrative and not limitative. For example, each component described as a single type may be implemented in a distributed manner, and similarly, components described as distributed may be implemented in a combined form.

The scope of the present invention is defined by the following claims, and all changes or modifications derived from the meanings and scope of the claims and equivalent concepts thereof should be interpreted as being included in the scope of the present invention.

1. An automatic car washing apparatus comprising:
a frame module unit configured to provide a vehicle accommodation space, and provided with guide frames;
a movable module unit configured to move along the guide frames, and provided with a blower unit that sprays air toward the vehicle accommodation space; and
a car washing module unit coupled to a rotor unit that is provided in the movable module unit, and configured to perform a washing operation on a vehicle that has entered the vehicle accommodation space;
wherein the car washing module unit is configured to rotate around a vertical axis of the rotor unit.

2. The automatic car washing apparatus of claim 1, wherein the frame module unit comprises:
main frames having a front frame and a rear frame that are spaced apart from each other by a predetermined distance and form the vehicle accommodation space;
support frames configured to connect the front frame and the rear frame;
the guide frames configured to connect the front frame and the rear frame and to guide the movable module unit through a moving direction thereof;
a front bracket protruding from the front frame toward the rear frame;
a rear bracket protruding from the rear frame toward the front frame;
a parking sensor unit installed on the front bracket, and configured to guide a vehicle, entering the vehicle accommodation space, to a parking location;
a front sensor unit spaced apart from the parking sensor unit by a predetermined distance, and installed on the front bracket; and
a rear sensor unit installed on the rear bracket.

3. The automatic car washing apparatus of claim 1, wherein the movable module unit comprises:
a casing having an installation space formed therein;
the blower unit provided in the installation space;
the rotor unit provided in the installation space, and configured to rotate the car washing module unit;
roller parts provided on both sides of the casing, and configured to move along longitudinal directions of the guide frames;
an extension part extending rearward from a center of the casing; and
a vehicle location sensor unit provided at an end of the extension part, and configured to detect a parking location of a vehicle entering the vehicle accommodation space.

4. The automatic car washing apparatus of claim 1, wherein the car washing module unit comprises:
a horizontal spray arm coupled to the rotor unit;
a connection spray arm configured such that one end thereof is connected to an end of the horizontal spray arm at a predetermined angle; and
a vertical spray arm connected to a remaining end of the connection spray arm; and
wherein a plurality of spray holes are formed in each of the horizontal spray arm, the connection spray arm, and the vertical spray arm at predetermined intervals along a longitudinal direction thereof.

5. The automatic car washing apparatus of claim 1, further comprising an entry guide unit configured to provide guidance to a parking location with respect to a widthwise direction of a vehicle entering the vehicle accommodation space;
wherein a bottom washing spray unit is provided on a bottom surface of the vehicle accommodation space.
